(19) United States
(12) Patent Application Publication
(10) Pub. No.: US 2013/0207321 A1
(43) Pub. Date: Aug. 15, 2013

(54) METHOD FOR MANUFACTURING A FIBRE REINFORCED COMPOSITE

(71) Applicant: Erik Grove-Nielsen, Roslev (DK)

(72) Inventor: Erik Grove-Nielsen, Roslev (DK)

(21) Appl. No.: 13/765,781

(22) Filed: Feb. 13, 2013

(30) Foreign Application Priority Data
Feb. 14, 2012 (EP) 12155366.3

(51) Int. Cl. B29C 45/02

(52) U.S. Cl. CPC B29C 45/02
USPC 264/571; 264/258

(57) ABSTRACT

A method for manufacturing a fibre reinforced composite is provided. Fibre material is connected together by a thread, wherein the thread has material which at least partly degrades before the manufacturing of the fibre reinforced composite is finished.

### CROSS REFERENCE TO RELATED APPLICATIONS

This application claims priority of European Patent Application No. 12155366.3 EP filed Feb. 14, 2012. All of the applications are incorporated by reference herein in their entirety.

### FIELD OF THE INVENTION

A method for manufacturing a fibre reinforced composite, for example a wind turbine rotor blade, is provided.

### BACKGROUND ART

Fibre reinforced plastic composites are used in a variety of technical products such as cars, aeroplanes, wind turbine blades, storage tanks etc. In many cases the fibre parts are placed in a mould. The mould is closed by a second mould part or a plastic foil is placed over the mould, and vacuum is applied to the fibre filled hollow structure. Hereafter the cavity is infused with a liquid resin, which later is cured to form a matrix material. The fibre parts are commonly supplied as fabrics of roving yarns, stitched together with thermoplastic sewing threads like thermoplastic polyester or PETP. Each roving yarn may hold 2-4000 single fibres. The stitching process mechanically stabilizes the roving yarns in a geometrically desirably pattern.

The tensioning of the stitching thread leads to local deformations of the unidirectional roving yarn bundles. In those areas the fibre content will reach an undesirably high value inside the roving yarn, and at the same time an area outside the roving yarn will be left without fibres. This area will have undesirably low fibre content or will consist of plastic resin alone. Areas that are not reinforced will be vulnerable to crack formation. It is also well known, that very high fibre content will impair the fatigue properties of a composite, as more fibres are in physical contact to neighbour fibres at extreme fibre contents. Thus high fibre content areas will have reduced fatigue properties. It is therefore desirable to obtain an even distribution of fibre content throughout the composite.

To avoid fatigue damage to composites made from fibre fabrics, the loading is normally reduced by designing a thicker laminate. This leads to parts that are heavier and more costly in materials and labour force.

### DESCRIPTION OF THE INVENTION

An objective is to provide a method for manufacturing a fibre reinforced composite using fibre material, wherein the uniformity of the fibre distribution is improved. This objective is solved by a method for manufacturing the fibre reinforced composite as claimed in the independent claim. The depending claims define further developments and embodiments.

The method for manufacturing a fibre reinforced composite using fibre material comprises the step of connecting fibre material together by means of a thread. The thread comprises a material which at least partly degrades before finishing the manufacturing process of the fibre reinforced composite. Preferably the thread consists of a material which at least partly degrades before finishing the manufacturing process. Advantageously the used thread fully degrades before finishing the manufacturing process of the fibre reinforced composite.

For example, the fibre material may be connected by stitching or knitting the fibre material together. Preferably a stitching thread or knitting thread is used for connecting the fibre material. Roving yarn or fibre fabrics can be used as fibre material.

A thread may be used which at least partly, preferably fully, degrades when certain production parameters in the production process are reached or changed. For example, a thread can be used which completely degrades or partly degrades by removing or loosing its tension. Moreover, liquid resin can be used for forming the matrix material of the composite. A thread can be used which comprises or consists of a material that dissolves in the liquid resin. Furthermore, a thread can be used which comprises or consists of a material that looses its tension when immersed in the resin.

In a further variant, a thread can be used which comprises or consists of hollow fibres that decompose or break when the thread with the hollow fibres is exposed to a particular pressure, for example a pressure below atmospheric pressure or partial vacuum.

Advantageously a thread can be used which comprises or consists of material which melts or sublimes when exposed to temperatures in a range between 50° C. to 100° C. For example, the thread may comprise material which begins to melt at a temperature between 50° C. and 60° C. or between 60° C. and 70° C. or between 70° C. and 80° C. or between 80° C. and 90° C. or between 90° C. and 100° C.

A further variant is using a semi permeable thread. The semi permeable thread can break up or decompose when it is filled with resin. For example, the rovings of the fabrics can be held in place by semi permeable threads, which break up or decompose when they are filled by resin, for instance due to capillary forces or osmotic pressure difference.

Semi-permeable threads can be used which are spun in helix formed shape. In this case the intake of resin by capillary forces or osmotic pressure can change the shape of the thread in a way, which prolongs the fibre and hence reduces the tension of the thread.

When the used thread degrades, or at least the tension of the thread is removed, then the fibres in the single roving yarns or fibre fabrics can move freely in the consolidation process. This results in a material with uniform fibre distribution and avoids resin rich pockets.

The manufactured fibre reinforced composite can be a wind turbine rotor blade. Generally, vacuum assisted resin transfer moulding (VARTM) can be used for manufacturing the composite, for example the wind turbine rotor blade.

The described embodiments have the following advantages: the fibre distribution of the manufactured item will be uniform throughout the laminate. The laminate will not contain resin rich pockets. The laminate will not contain areas of excess fibre content. Furthermore, the fatigue properties of the laminate will be higher due to an even fibre distribution. The laminate will be more resistant to crack formation. A lighter laminate with improved fatigue resistance can be produced and the composite parts can be produced at a reduced cost.

Further features, properties and advantages will become clear from the following description of an embodiment in conjunction with the accompanying drawings. The embodiment does not limit the scope of the present invention which is determined by the appended claims. All described features are advantageous as separate features or in any combination with each other.

BRIED DESCRIPTION OF THE FIGURES

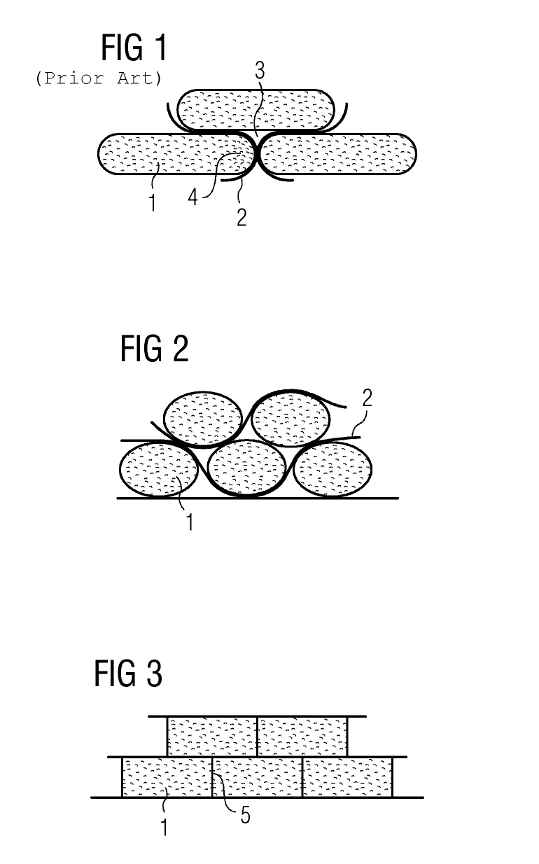

FIG. 1 schematically shows a cross section of a laminate stack in a cured composite part according to the state of the art.

FIG. 2 schematically shows a cross section of a laminate stack before consolidation and degradation of stitching thread according to an embodiment.

FIG. 3 schematically shows a cross section of part of a laminate stack after consolidation and degradation of stitching threads according to an embodiment.

### DESCRIPTION OF EMBODIMENTS

An embodiment will now be described with reference to FIGS. 1 to 3. FIG. 1 schematically shows part of a laminate stack in a cured composite part as obtained using state of the art techniques.

FIG. 1 shows a sectional view perpendicular to the main fibre direction. A number of roving yarns 1 are placed side by side and onto each other. The roving yarns 1 are hold in place during the manufacturing process by means of stitching threads 2. The tensioning of the stitching threads 2 leads to local deformations of the unidirectional fibre roving yarn bundles 1. In those areas the fibre content will reach an undesirably high value inside the roving yarn. This is indicated by reference numeral 4, which designates a high fibre content area in a roving yarn due to constriction. At the same time an area outside the roving yarn is left without fibres. This area, which is indicated by reference numeral 3, has undesirably low fibre content and will consist of plastic resin alone and forms a so-called resin pocket with no fibre content.

FIG. 2 schematically shows a cross section of part of a laminate stack before consolidation and degradation of the stitching thread according to an embodiment. A number of roving yarns 1 are stitched together by means of a stitching thread 2 and are for example placed in a mould for applying vacuum assisted resin transfer moulding.

The stitching thread or knitting thread 2 at least partly degrades, preferably fully degrades, when certain production parameters in the production process are reached or change. For example, the thread 2 may loose or remove its tension due to capillary forces or osmotic pressure caused by infused resin. Advantageously the thread may be a semi permeable thread which is spun in a helix formed shape. Moreover, the used thread 2 may be a semi permeable thread, which breaks up or decomposes when filled with resin.

A further variant is to use a thread 2 which partly or completely dissolves in liquid resin. Furthermore, the thread 2 may consist of hollow fibres that decompose or break up when exposed to a particular pressure. The particular pressure may be the pressure which is reached when applying vacuum in a vacuum assisted resin transfer moulding process when sucking in resin and distributing resin in the fibre material.

In a further variant or additionally the used thread 2 comprises or consists of material which melts or sublimes when exposed to temperatures in a range between 50° C. and 100° C. In this case the temperature of the laminate stack can be increased to a temperature between 50° C. and 100° C. before or when infusing resin into the structure.

FIG. 3 schematically shows a cross section of the laminate stack after consolidation and degradation of the stitching threads 2. The roving yarn 1 shows a uniform fibre distribution throughout the laminate. The stitching thread 2 is at least partly decomposed and thus does not cause resin rich pockets or areas with high fibre content as shown in FIG. 1. The space between the roving yarns is indicated by reference numeral 5 in FIG. 2. These pockets are now collapsed as shown in FIG. 3.

Preferably the described method can be used for manufacturing a fibre reinforced composite such as a wind turbine rotor blade. By using the described method the mechanical properties of the obtained composite are improved, especially by avoiding resin rich pockets and areas of excess fibre content. Due to the obtained even fibre distribution the fatigue properties of the laminate are increased. Furthermore, the risk of crack formation is reduced and a lighter laminate with improved fatigue resistance is obtained.

1. A method of manufacturing a fibre reinforced composite using fibre material, comprising:
connecting fibre material by a thread comprising a material which at least partly degrades before finishing the manufacturing process.

2. The method as claimed in claim 1, wherein the fibre material is connected by stitching or knitting the fibre material.

3. The method as claimed in claim 1, wherein the fibre material is selected from the group consisting of roving yarn, fibre fabrics, and a combination thereof.

4. The method as claimed in claim 1, wherein the thread at least partly degrades when certain production parameters in the manufacturing process are reached or change.

5. The method as claimed in claim 1, wherein the thread completely degrades or partly degrades by removing or loosing its tension.

6. The method as claimed in claim 1, further comprising:
impregnating the fibre material using liquid resin, wherein the thread comprises material which dissolves in the liquid resin.

7. The method as claimed in claim 1, further comprising:
impregnating the fibre material using liquid resin, wherein the thread comprises material which looses tension when immersed in the liquid resin.

8. The method as claimed in claim 1, wherein the thread comprises hollow fibres which decompose or break when exposed to pressure.

9. The method as claimed in claim 1, wherein the thread comprises material which melts or sublimes when exposed to temperatures between 50° C. to 100° C.

10. The method as claimed in claim 1, wherein the thread is a semi-permeable thread.

11. The method as claimed in claim 10, wherein the semi-permeable thread breaks up or decomposes when impregnated with resin.

12. The method as claimed in claim 10, wherein the semi-permeable thread is spun in helix formed shape.

13. The method as claimed in claim 1, wherein the fibre reinforced composite is a wind turbine rotor blade.

14. The method as claimed in claim 1, wherein Vacuum Assisted Resin Transfer Moulding is used for manufacturing the fibre reinforced composite.
